(19) United States
(12) Patent Application Publication
(10) Pub. No.: US 2021/0185420 A1
(43) Pub. Date: Jun. 17, 2021

(54) BONE CONDUCTION MICROPHONE AND BONE CONDUCTION HEADSET

(71) Applicant: PANASONIC INTELLECTUAL PROPERTY MANAGEMENT CO., LTD., Osaka (JP)

(72) Inventors: Kei TASAKA, Osaka (JP); Suguru NAKAO, Hyogo (JP); Hiroshi KUNIMOTO, Osaka (JP); Katsuo SAIGOU, Hyogo (JP)

(21) Appl. No.: 17/183,256

(22) Filed: Feb. 23, 2021

Related U.S. Application Data
(63) Continuation of application No. PCT/JP2019/030386, filed on Aug. 2, 2019.

(30) Foreign Application Priority Data
Aug. 30, 2018 (JP) 2018-161595

(51) Int. Cl. H04R 1/08; H04R 1/10; H04R 1/46

(52) U.S. Cl. CPC H04R 1/083; H04R 2460/13; H04R 1/46; H04R 1/1008

(57) ABSTRACT

A bone conduction microphone of the present disclosure includes: a vibration sensor that comes into contact with a nose of a living body from outside the living body and converts vibration into an electric signal; a head-worn part that is worn on a head of the living body; and a sensor support that hangs from the head-worn part and supports the vibration sensor toward the nose.

### BACKGROUND

### 1. Technical Field

The present disclosure relates to a bone conduction microphone and a bone conduction headset.

### 2. Description of the Related Art

When a person speaks, the vocal cords vibrate, causing oral resonance and nasal resonance. As a microphone for collecting human voice, a voice microphone and a bone conduction microphone are known. The voice microphone detects voice as air vibration and converts it into an electric signal. The bone conduction microphone detects voice emitted by the person oneself as vibration of skin on the mandible due to oral resonance and skin on a nasal bone due to nasal resonance, and converts it into an electric signal. In recent years, attention has been focused on bone conduction microphones that are less likely to be affected by ambient noise.

Patent Literature (PTL) 1 discloses a hands-free communication unit equipped with a bone conduction microphone that picks up vibration of skin on the nosal bone with a vibration sensor built into a nose pad of glasses and converts it into an electric signal (hereinafter, referred to as “glasses with a bone conduction microphone”).

PTL 1 is Unexamined Japanese Patent Publication No. 8-298694.

### SUMMARY

The present disclosure provides a bone conduction microphone and a bone conduction headset that allow the bone conduction microphone to be separately worn and can suppress decrease in detection accuracy of vibration of skin on a nasal bone even when a human body wears glasses.

An aspect of the present disclosure is a bone conduction microphone including: a vibration sensor that comes into contact with a nose of a living body from outside the living body and converts vibration into an electric signal; a head-worn part that is worn on a head of the living body; and a sensor support that hangs from the head-worn part and supports the vibration sensor toward the nose.

Another aspect of the present disclosure is a bone conduction headset including: a vibration sensor that comes into contact with a nose of a living body from outside the living body and converts vibration into an electric signal; a head-worn part that is worn on a head of the living body; a sensor support that hangs from the head-worn part and supports the vibration sensor toward the nose; and a bone conduction speaker that is connected to the head-worn part and outputs a voice signal by vibration.

According to the present disclosure, even when a living body wears glasses, a bone conduction microphone can be separately worn, and decrease in detection accuracy of vibration of skin on a nasal bone can be suppressed.

### BRIEF DESCRIPTION OF DRAWINGS

FIG. 1 is a perspective view illustrating a wearing state of a bone conduction microphone of a first exemplary embodiment.

FIG. 2 is a perspective view illustrating a wearing state of a bone conduction microphone of a second exemplary embodiment.

FIG. 3 is a perspective view illustrating a wearing state of a bone conduction microphone of a third exemplary embodiment.

FIG. 4 is a front view illustrating a state of the bone conduction microphone of the third exemplary embodiment when it is not worn.

FIG. 5A is a diagram illustrating structure of a connecting portion between a head-worn part body and a support base member in the bone conduction microphone of the third exemplary embodiment, and is a perspective view seen from the outside (front side).

FIG. 5B is a diagram illustrating the structure of the connecting portion between the head-worn part body and the support base member in the bone conduction microphone of the third exemplary embodiment, and is a perspective view seen from the inside (back side).

FIG. 6A is a schematic view illustrating structure of a clip in a bifurcated shape in the bone conduction microphone of the third exemplary embodiment, and is a front view illustrating a state in which two arms of the clip are closed by spring force when the clip is not worn.

FIG. 6B is a schematic view illustrating the structure of the clip in the bifurcated shape in the bone conduction microphone of the third exemplary embodiment, and is a front view illustrating a state in which the two arms of the clip are opened against the spring force when the clip is worn.

FIG. 7 is a front view illustrating a state of a bone conduction microphone of a fourth exemplary embodiment when it is not worn.

FIG. 8 is a perspective view illustrating a wearing state of a bone conduction headset configured using the bone conduction microphone of the second exemplary embodiment as a fifth exemplary embodiment.

### DETAILED DESCRIPTION

Hereinafter, exemplary embodiments will be described in detail with appropriate reference to the drawings. However, unnecessarily detailed description may be eliminated. For example, detailed description of a well-known item or duplicated description of a substantially identical configuration may be eliminated. This is to prevent the following description from being unnecessarily redundant to facilitate understanding of those skilled in the art. The attached drawings and the following description are provided for those skilled in the art to fully understand the present disclosure, and are not intended to limit the subject matter described in the scope of claims.

### Background to Obtain an Aspect of the Present Disclosure

A hands-free calling unit equipped with the bone conduction microphone described in PTL 1 incorporates a vibration sensor in a nose pad portion of glasses, and thus can be worn as if glasses are worn, thereby having an advantage of easy wearing. Unfortunately, when a person wearing other glasses such as corrective glasses or dust-proof glasses tries to use glasses with a bone conduction microphone, positions of the other glasses and the glasses with a bone conduction microphone overlap, and thus causing difficulty in wearing both. When both the other glasses and the glasses with a bone conduction microphone are worn, the glasses with a bone conduction microphone are to be worn from above or below the other glasses while overlapping the other glasses. This causes a nose pad portion of the other glasses to interfere with a nose pad portion of the bone conduction microphone. Thus, the glasses with a bone conduction microphone are less likely to properly pick up vibration of skin on a nasal bone.

In other words, those who need to wear different glasses need to prepare new dedicated glasses with a bone conduction microphone in which a correction lens or a dustproof lens is preliminarily fitted in a frame of the glasses with a bone conduction microphone. Thus, the hands-free calling unit described in PTL 1 causes those who need to wear different glasses to have more cost or an inconvenient use, for example.

The following exemplary embodiments each describe a bone conduction microphone and a bone conduction headset that allow the bone conduction microphone to be separately worn and can suppress decrease in detection accuracy of vibration of skin on a nasal bone even when a living body wears glasses.

### First Exemplary Embodiment

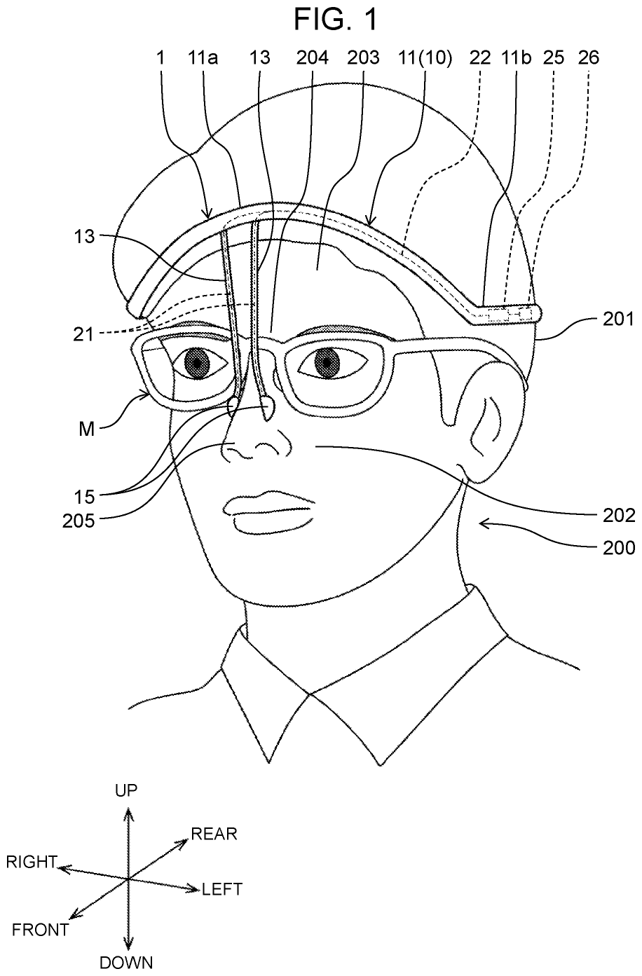

First, a bone conduction microphone of a first exemplary embodiment will be described. FIG. 1 is a perspective view illustrating a wearing state of the bone conduction microphone of the first exemplary embodiment. FIG. 1 shows up-and-down, front-back, and left-right directions. These directions are based on front-back, up-and-down, and left-right directions as seen from a person. The up-and-down, front-back, and left-right directions are identical in every exemplary embodiment.

As illustrated in FIG. 1, bone conduction microphone 1 of the first exemplary embodiment includes left and right vibration sensors 15 that come into contact with nose 205 at the center of face 202 of wearer (human body) 200 from outside the human body and converts vibration of skin on a nasal bone into an electric signal. Bone conduction microphone 1 includes headband 11 as a head-worn part to be worn on head 201 above nose 205. Bone conduction microphone 1 includes two sensor support wires 13 as sensor supports that extend downward from central portion 11a in the left-right direction of headband 11 and support left and right vibration sensors 15 toward nose 205. The human body is an example of a living body, and another living body (e.g., an animal) may be applicable.

Headband 11 is an elastic C-shaped head wearer and is worn such that central portion 11a thereof is positioned on a frontal region above forehead 203 while an open portion of the C-shape is expanded to allow end portions 11b (opposite end portions) in the left-right direction to be each positioned in the temporal region behind the ears. As a result, headband 11 is securely worn on head 201 due to elastic force of end portions 11b (opposite end portions) in the left-right direction, acting to narrow a distance between end portions 11b.

Headband 11 can be made of resin or metal. Here, as an example, headband 11 is made of resin in consideration of wearability and weight.

Two sensor support wires 13 are each connected at its upper end to central portion 11a of headband 11 in the left-right direction and hang down passing through the front of glabella 204 and extending downward. Then, left and right vibration sensors 15 are attached to lower ends of respective two sensor support wires 13. That is, vibration sensors 15 includes a vibration sensor that comes into contact with the left side of the nose and a vibration sensor that comes into contact with the right side of the nose.

Sensor support wires 13 are each configured to be able to hold its form acquired by freely bent deformation or freely curved deformation. This enables vibration sensors 15 to be easily adjusted in position and orientation. Sensor support wires 13 may be made of metal or may be made of elastic resin.

One of end portions 11b of headband 11 in the left-right direction (the left end part located above the left ear in the illustrated example) incorporates wireless module 25 that is an electronic circuit and battery 26 that is a power supply. Wireless module 25 operates by being supplied with power from battery 26, and has a function of wirelessly transmitting a detection signal of vibration sensor 15 to the outside (e.g., a smartphone existing near bone conduction microphone 1). As an example of wireless module 25, a Bluetooth (registered trademark) low energy (BLE) module, i.e., a wireless module for Bluetooth (registered trademark), a near field communication (NFC) module, i.e., a module for short-range communication, a wireless local area network (LAN) module, or the like can be appropriately used. Wireless module 25 and battery 26 can be disposed at any position in headband 11. For example, wireless module 25 and battery 26 may be disposed near central portion 11a in the left-right direction.

Conductor wires 21, 22 for signal transmission from vibration sensor 15 to wireless module 25 are configured to pass through inside sensor support wires 13 and headband 11. Sensor support wires 13 are each composed of, for example, a thin tube, and each of conductor wires 21 connected to respective vibration sensors 15 pass through inside the tube. Two conductor wires 21, each of which protruding from an upper end of the tube of sensor support wire 13, are combined into one conductor wire 22 and connected to wireless module 25 through a hollow portion of headband 11 or the like.

Any wiring manner can be appropriately selected other than a method of allowing conductor wires 21 and 22 to pass through respective sensor support wires 13, and headband 11. For example, sensor support wire 13 itself may be formed of a metal wire to also function as conductor wire 21. Headband 11 may be provided on its surface with plated wiring or the like.

Next, action will be described.

To use this bone conduction microphone 1, as illustrated in FIG. 1, headband 11 is worn on head 201, and left and right vibration sensors 15 supported at lower ends of respective sensor support wires 13 are pressed against corresponding right and left skin surfaces at places with nasal bone of nose 205. This causes left and right vibration sensors 15 to pinch nose 205 from both sides of the nasal bone.

When wearer 200 speaks in this state, vibration caused by the speaking is transmitted to the nasal cavity, and vibration of the skin on the nasal bone is detected by vibration sensors 15 pressed against nose 205. Then, a detected signal (detection signal) is transmitted to wireless module 25 and is processed as necessary. Then, the detected signal is transmitted to an external communication terminal, such as a smartphone, using wireless module 25 or the like.

As illustrated in FIG. 1, even when wearer 200 wears glasses M, such as corrective glasses, bone conduction microphone 1 can be worn without interfering with glasses M. That is, sensor support wires 13 allows respective vibration sensors 15 to be in contact with nose 205 while avoiding the frame of glasses M, so that bone conduction microphone 1 can be worn regardless of whether glasses M are worn. Bone conduction microphone 1 includes sensor support wires 13 that pass through between both eyes, so that limitation of a field of view can be suppressed as much as possible.

Bone conduction microphone 1 also can adjust a position and an orientation of each of vibration sensors 15 in contact with nose 205 by adjusting a bending degree of the corresponding one of sensor support wires 13. This enables bone conduction microphone 1 to prevent vibration sensors 15 from interfering with a nose pad portion of glasses M even when wearer 200 wears glasses M. Thus, decrease in detection accuracy of vibration sensors 15 can be suppressed.

When sensor support wires 13 each have an adjustment function, bone conduction microphone 1 enables each of vibration sensors 15 to come into close contact with a position with high sensitivity in accordance with a position and a size of nose 205, and thus vibration of skin on the nasal bone can be appropriately picked up.

Conductor wires 21 pass through inside respective sensor support wires 13, so that conductor wires 21 can be hidden to be invisible from the outside. This enables improving appearance and preventing conductor wires 21 from blocking a part of a field of view.

### Second Exemplary Embodiment

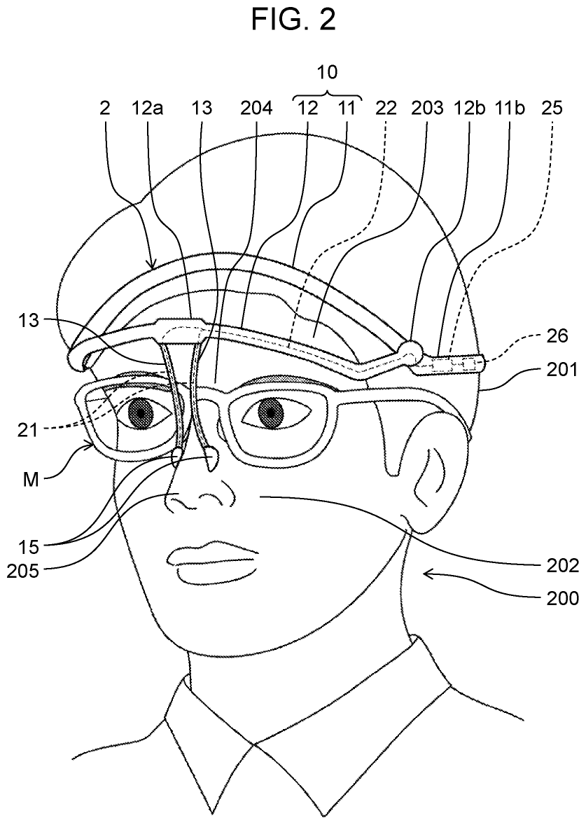

Next, a bone conduction microphone of a second exemplary embodiment will be described. FIG. 2 is a perspective view illustrating a wearing state of the bone conduction microphone of the second exemplary embodiment.

As illustrated in FIG. 2, bone conduction microphone 2 of the second exemplary embodiment is different from bone conduction microphone 1 of the first exemplary embodiment illustrated in FIG. 1 in that support frame 12 (an example of the support base member) is provided between sensor support wires 13 and headband 11. Support frame 12 is a rod-shaped member curved in a C-shape and elongated in the left-right direction, and is connected at end portions 12b in the left-right direction to near corresponding end portions 11b in the left-right direction of headband 11.

This allows central portion 12a of support frame 12 in the left-right direction to be supported in a noncontact manner in a floating state in front of forehead 203 when headband 11 is worn on head 201. Then, upper ends of respective sensor support wires 13 on the left and right having lower ends with respective vibration sensors 15 attached are connected to central portion 12a of support frame 12. Here, headband 11 and support frame 12 constitute head-worn part 10, and headband 11 corresponds to the head-worn part body. Support frame 12 may be made of metal, or may be made of resin from the viewpoint of weight reduction and manufacturability.

Bone conduction microphone 2 also includes two conductor wires 21, through which signals detected by corresponding vibration sensors 15 are transmitted, pass through respective sensor support wires 13 and are combined into one conductor wire in support frame 12. The one conductor wire is connected to wireless module 25 incorporated in a left end portion of headband 11 from central portion 12a of frame 12 through a connecting portion.

When a wearer wears this bone conduction microphone 2, upper ends of sensor support wires 13 are connected to support frame 12 disposed in a noncontact manner in a floating state in front of forehead 203. Thus, vibration, such as scratching noise at a worn portion that may occur in head-worn part 10, is less likely to be transmitted to vibration sensors 15 through corresponding sensor support wires 13. This causes bone conduction microphone 2 to be less likely to pick up noise, so that detection accuracy of nasal bone vibration can be improved.

Bone conduction microphone 2 includes sensor support wires 13 that hang down from central portion 12a of support frame 12 protruding in front of forehead 203. In this case, unlike sensor support wires 13 that is hung down from directly above nose 205 and being parallel to face 202, bone conduction microphone 2 enables sensor support wires 13 to hang down at an angle toward nose 205 from the front of forehead 203, i.e., toward a direction (rear) in which sensor support wires 13 gradually approaches face 202 from the front of face 202. Thus, bone conduction microphone 2 allows vibration sensors 15 to be likely to press against nose 205 more appropriately.

Sensor support wires 13 are each connected at its upper end to support frame 12 located in front of forehead 203, so that sensor support wires 13 extending from support frame 12 to corresponding vibration sensors 15 can be shortened in length. For example, when sensor support wires 13 are each made of a thin tubular wire, increase in length reduces strength thereof. This may cause improper pressing of vibration sensors 15 against nose 205. In contrast, bone conduction microphone 2 enables sensor support wires 13 to be shortened in length, so that decrease in strength of each of sensor support wires 13 can be suppressed. In other words, when sensor support wires 13 are each shortened in length, bone conduction microphone 2 enables each of sensor support wires 13 to be made of a thinner wire. This enables further suppressing obstruction of a field of view.

Wireless module 25 and battery 26 may be provided in headband 11 or in support frame 12 as in the first exemplary embodiment.

### Third Exemplary Embodiment

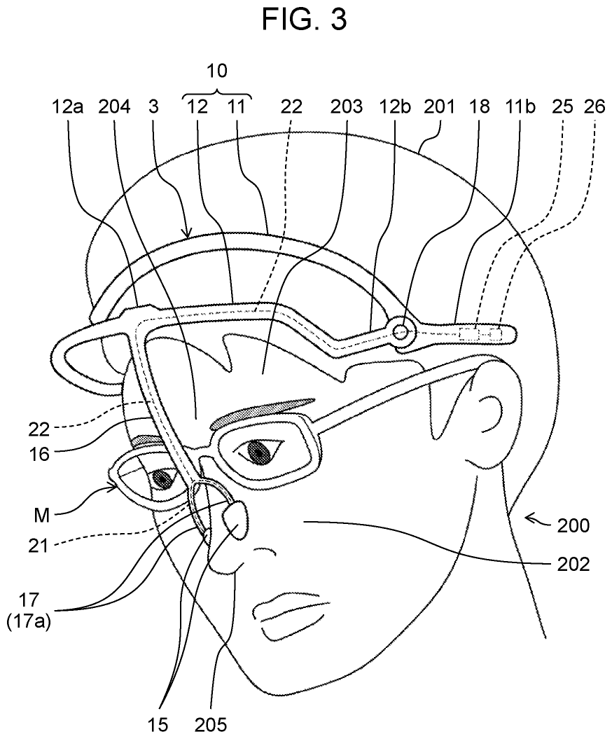

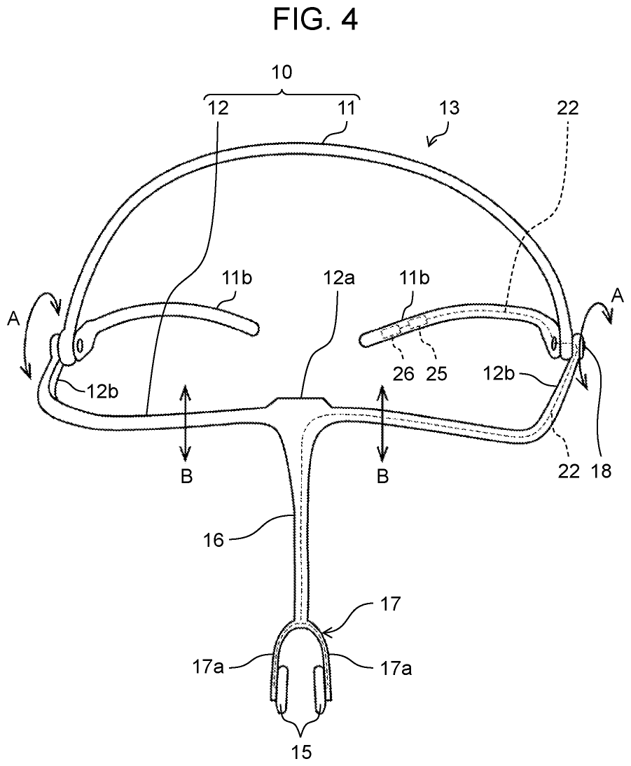

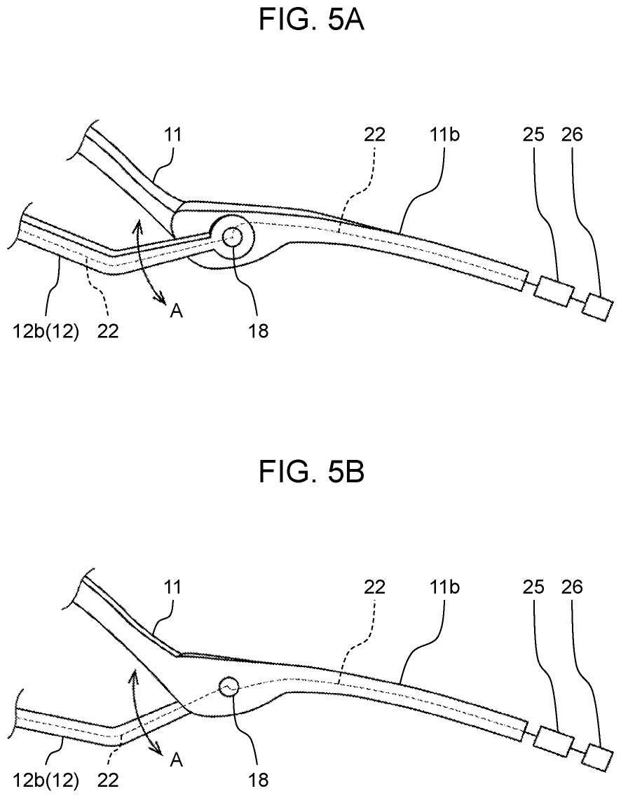

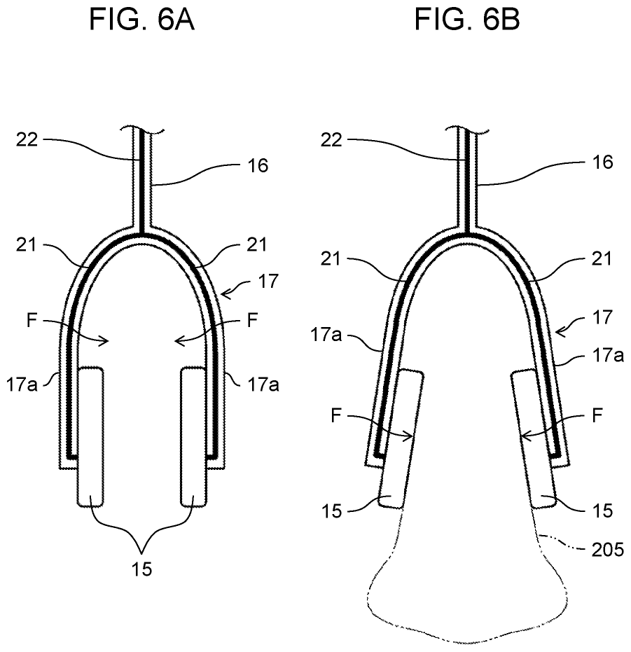

Next, a bone conduction microphone of a third exemplary embodiment will be described. FIG. 3 is a perspective view illustrating a wearing state of the bone conduction microphone of the third exemplary embodiment. FIG. 4 is a front view illustrating a state of a bone conduction microphone when it is not worn. FIG. 5A is a diagram illustrating structure of a connecting portion between a head-worn part body and a support base member in the bone conduction microphone, and is a perspective view seen from the outside (front side). FIG. 5B is a diagram illustrating the structure of the connecting portion between the head-worn part body and the support base member in the bone conduction microphone, and is a perspective view seen from the inside (back side). FIG. 6A is a schematic view illustrating structure of a clip in a bifurcated shape in the bone conduction microphone, and is a front view illustrating a state in which two arms of the clip are closed by spring force (elastic force) when the clip is not worn. FIG. 6B is a schematic view illustrating structure of the clip in a bifurcated shape in the bone conduction microphone, and is a front view illustrating a state in which the two arms of the clip are opened against the spring force when the clip is worn.

As illustrated in FIGS. 3 and 4, difference between bone conduction microphone 3 of the third exemplary embodiment and bone conduction microphone 2 of the second exemplary embodiment illustrated in FIG. 2 includes two points below. Specifically, one sensor support rod 16 is provided instead of two sensor support wires 13, and vibration sensors 15 are attached to a lower end of sensor support rod 16 using clip 17 in a bifurcated shape. Additionally, end portions 12b (opposite end portions) of support frame 12 in the left-right direction are connected to headband 11 in a rotatable manner in the up-and-down direction (vertical direction).

As illustrated in detail in FIGS. 5A and 5B, end portions 12b of support frame 12 in the left-right direction are connected to respective portions near corresponding end portions 11b of headband 11 in the left-right direction, headband 11 being the head-worn part body, in a rotatable manner in the up-and-down direction (arrow A direction) using connecting pin 18. This enables bone conduction microphone 3 to allow central portion 12a of support frame 12 to be adjusted in position in the up-and-down direction (arrow B direction) as illustrated in FIG. 4.

Sensor support rod 16 is bendable and integrally connected at its upper end to central portion 12a of support frame 12. Sensor support rod 16 may be formed by resin molding integrally with support frame 12. As illustrated in FIG. 6A, sensor support rod 16 is provided at its lower end with clip 17 in a bifurcated shape. Clip 17 in a bifurcated shape includes two arms 17a extending downward and generates urging force F in a direction of closing two arms 17a. Two arms 17a of clip 17 have respective leading ends to which corresponding left and right vibration sensors 15 are attached, vibration sensors 15 coming into contact with corresponding left and right sides of nose 205. Here, sensor support rod 16 and clip 17 in a bifurcated shape constitute a sensor support.

Conductor wires 21 coming out of respective vibration sensors 15 passes through corresponding arms 17a of clip 17 and are combined into one conductor wire 22 inside sensor support rod 16. Then, conductor wire 22 passes through support frame 12, a rotary connecting portion using connecting pin 18, and headband 11 in this order to be connected to wireless module 25.

Bone conduction microphone 3 includes support frame 12 that is rotatable in the up-and-down direction, and sensor support rod 16 that is bendable. Thus, when a wearer wears this bone conduction microphone 3, bone conduction microphone 3 enables each of vibration sensors 15 to easily come into contact with nose 205 at an appropriate position with good sensitivity from an appropriate direction by adjusting a position of support frame 12 in the up-and-down direction and bending sensor support rod 16 even when head 201 is individually different in size and nose 205 is individually different in size and position.

Bone conduction microphone 3 includes vibration sensors 15 that are attached to respective leading ends of arms 17a, which generates urging force F, of clip 17 in a bifurcated shape, so that vibration sensors 15 each can be pressed against nose 205 with appropriate pressing force as illustrated in FIG. 6B. Thus, bone conduction microphone 3 is excellent in wearability, and enables vibration of skin on the nasal bone to be appropriately picked up with good sensitivity, and also enables reducing individual difference in sensitivity of vibration sensor 15 regardless of the size of nose 205.

Bone conduction microphone 3 enables conductor wire 22 to be hidden to be invisible from the outside by allowing conductor wire 22 to pass through sensor support rod 16, and enables conductor wires 21 protruding from respective vibration sensors 15 to be easily combined into one conductor wire within a range of length of sensor support rod 16.

Bone conduction microphone 3 includes sensor support rod 16 that may be composed of a metal wire, and clip 17 that may be integrally formed with sensor support rod 16.

### Fourth Exemplary Embodiment

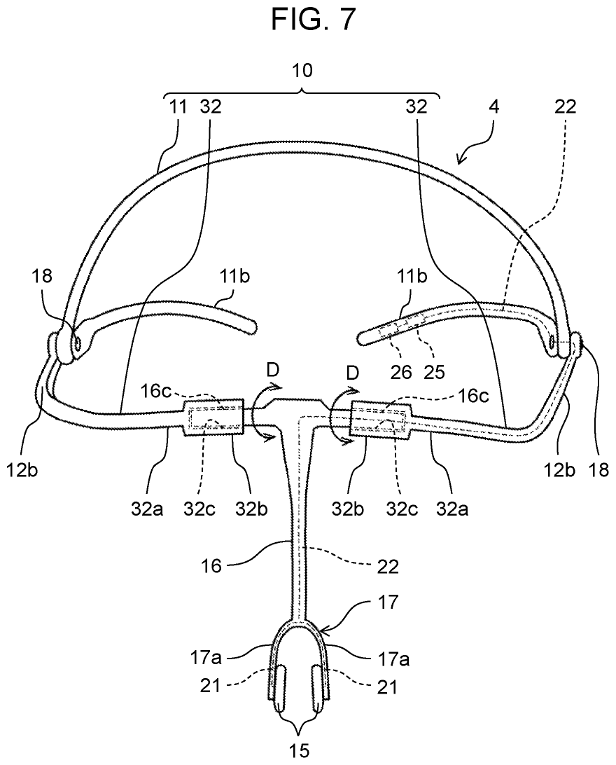

Next, a bone conduction microphone of a fourth exemplary embodiment will be described. FIG. 7 is a front view illustrating a state of the bone conduction microphone of the fourth exemplary embodiment when it is not worn.

As illustrated in FIG. 7, bone conduction microphone 4 of the fourth exemplary embodiment is different from bone conduction microphone 3 of the third exemplary embodiment illustrated in FIG. 3 in that sensor support rod 16 is connected to support frame 32 (an example of the support base member) in a rotatable manner in the up-and-down direction.

Support frame 32 is divided at its center into left and right frames 32a, 32a at an interval, and bearing holes 32c, 32c are provided at the left and right divided end portions 32b, 32b, respectively. Then, sensor support rod 16 has an upper end portion formed in a T-shaped bar shape, and two shaft portions 16c, 16c protruding to the left and right are inserted into corresponding bearing holes 32c, 32c of left and right frames 32a, 32a. This allows sensor support rod 16 to be connected to support frame 12 in a rotatable manner in the up-and-down direction (arrow D direction). In this case, headband 11 and support frame 32 constitute a head-worn part, and headband 11 corresponds to the head-worn part body.

Conductor wires 21 coming out of respective vibration sensors 15 pass through corresponding arms 17a of clip 17 in a bifurcated shape and are combined into one conductor wire 22 inside sensor support rod 16. Then, conductor wire 22 is guided to support frame 12 through shaft portion 16a and bearing hole 32c, and passes through a rotary connecting portion using connecting pin 18, and headband 11 in this order to be connected to wireless module 25. Conductor wire 22 may be wired without passing through a rotation mechanism portion.

When a wearer wears this bone conduction microphone 4, bone conduction microphone 4 enables each of vibration sensors 15 to easily come into contact with nose 205 at an appropriate position by rotating sensor support rod 16 in the up-and-down direction even when nose 205 is individually different in size and position. That is, bone conduction microphone 4 facilitates adjusting a position and pressure at which vibration sensors 15 come into contact with nose 205.

### Fifth Exemplary Embodiment

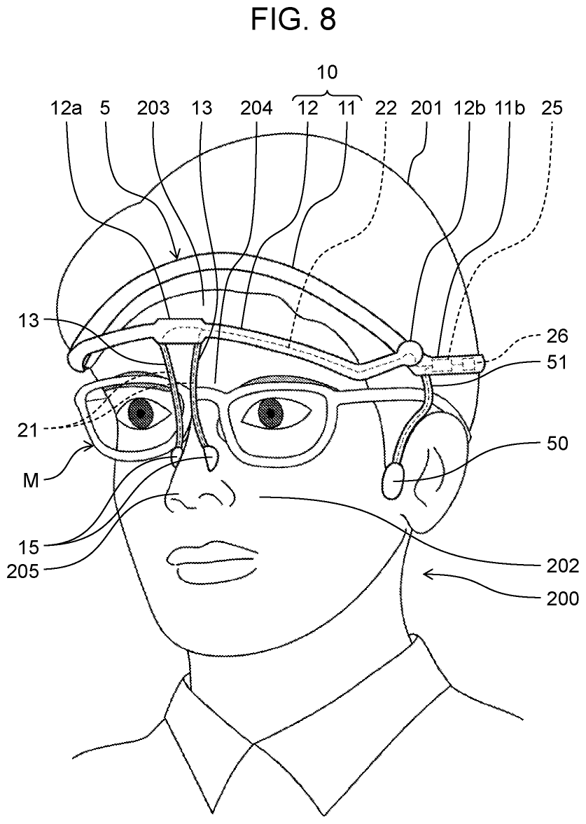

Next, a headset including a bone conduction microphone will be described as a fifth exemplary embodiment. FIG. 8 is a perspective view illustrating a wearing state of bone conduction headset 5 configured using bone conduction microphone 2 of the second exemplary embodiment as the fifth exemplary embodiment. The bone conduction headset may be configured using the bone conduction microphone of another exemplary embodiment.

As illustrated in FIG. 8, bone conduction headset 5 of the fifth exemplary embodiment is different from bone conduction microphone 2 of the second exemplary embodiment illustrated in FIG. 2 in that bone conduction speaker 50 is additionally provided.

Bone conduction speaker 50 is supported with arm 51 extending from a left end portion of headband 11 to be able to come into contact with a portion with a bone near an ear, such as a portion in front of or behind the ear. Bone conduction speaker 50 is electrically connected to wireless module 25 to acquire a voice signal from wireless module 25, and then outputs the voice signal by generating vibration corresponding to the audio signal.

When a wearer wears this bone conduction headset 5, bone conduction headset 5 enables transmitting desired sounds clearly to wearer 200 by bone conduction using bone conduction speaker 50 even in a situation with a large ambient noise.

As described above, even when corrective glasses or dust-proof glasses are worn, the bone conduction microphone and the bone conduction headset described in each of the above exemplary embodiments can be worn above the glasses without interfering with the glasses. The bone conduction microphone and the bone conduction headset also can bring each of vibration sensors 15 into contact with the nose at a proper position, and can detect vibration of skin of the nose at the time of nasal resonance.

Although the exemplary embodiments have been described above with reference to the drawings, it is needless to say that the present disclosure is not limited to such examples. It is obvious to those skilled in the art that various modification examples, modification examples and corrective examples can be conceived within the scope of claims, and thus it is obviously understood that those examples belong to the technical scope of the present disclosure.

At least some of the above exemplary embodiments may be combined with another exemplary embodiment.

As described above, the bone conduction microphone of each of the above exemplary embodiments may include vibration sensor 15 that comes into contact with nose 205 of a human body (an example of a living body, such as wearer 200) from outside the human body and converts vibration of skin on a nasal bone to an electric signal, head-worn part 10 to be worn on the head of the human body above the nose, and a sensor support (e.g., sensor support wire 13 and sensor support rod 16 provided at its lower end with clip 17) extending downward from head-worn part 10 to support vibration sensor 15 toward nose 205.

As a result, even when corrective glasses or dust-proof glasses are worn, the bone conduction microphone can be worn above the glasses without interfering with the glasses. That is, the bone conduction microphone can be worn regardless of whether a wearer wears glasses. Even when glasses are worn, the bone conduction microphone can prevent vibration sensor 15 from interfering with a nose pad portion of the glasses by adjusting a position at which vibration sensor 15 comes into contact with the nose. Thus, the bone conduction microphone can suppress decrease in detection accuracy of vibration sensor 15. The bone conduction microphone can adjust the position at which the vibration sensor comes into contact with the nose by providing the sensor support with an adjustment function. Thus, the bone conduction microphone enables vibration sensor 15 to come into close contact with a position with high sensitivity in accordance with a position and a size of nose 205, and enables vibration of skin on the nasal bone to be appropriately picked up.

The sensor support may extend downward from its upper end connected to head-worn part 10 and pass through a portion in front of glabella 204 of head 201 of the human body to support vibration sensor 15.

As a result, the bone conduction microphone includes the sensor support that passes through between both eyes, so that limitation of a field of view can be suppressed as much as possible.

Head-worn part 10 may include a head-worn part body (e.g., headband 11) to be worn on head 201, and a support base member (e.g., support frame 12) that is supported by the head-worn part body when being connected to end portions 11b (opposite end portions) of the head-worn part body in the left-right direction positioned near a temporal region when the head-worn part body is worn on head 201, the support base member allowing central portion 11a to be located in front of forehead 203 of head 201 of the human body in a noncontact manner in a floating state and being connected to an upper end of the sensor support.

As a result, the upper end of the sensor support is connected to the support base member located in front of forehead 203 in a noncontact manner in a floating state when being worn, so that vibration, such as scratching noise at a worn portion that may occur in head-worn part 10, is less likely to be transmitted to vibration sensor 15 through the sensor support. This causes the bone conduction microphone to be less likely to pick up noise, so that detection accuracy of nasal bone vibration can be improved. The bone conduction microphone includes the sensor support that hangs down from central portion 12a of the support base member protruding in front of forehead 203, so that the sensor support can be hung down at an angle toward the nose from the front of forehead 203, i.e., toward a direction (rear) in which sensor support wires 13 gradually approaches face 202 from the front of face 202, unlike the sensor support that is hung down from directly above the nose and being parallel to face 202. Thus, the bone conduction microphone allows vibration sensor 15 to be likely to press against nose 205 more appropriately.

The upper end of the sensor support is connected to the support base member located in front of forehead 203, so that the bone conduction microphone enables the sensor support extending from the support base member to vibration sensor 15 to be shortened in length. For example, when the sensor support is made of a thin tubular wire, increase in length reduces strength thereof. This may cause improper pressing of vibration sensor 15 against nose 205. In contrast, the bone conduction microphone enables the sensor support to be shortened in length, so that decrease in strength of the sensor support can be suppressed. In other words, when the sensor support is shortened in length, the bone conduction microphone enables the sensor support to be made of a thinner wire.

Opposite end portions of the support base member may be connected to the head-worn part body in a rotatable manner in the up-and-down direction.

As a result, even when the head is individually different in size and the nose is individually different in size and position, the bone conduction microphone enables vibration sensor 15 to come into contact with nose 205 at an appropriate position by adjusting a position of the support base member in the up-and-down direction. Thus, the bone conduction microphone can be improved in wearability.

The sensor support may be connected to the support base member in a rotatable manner in the up-and-down direction.

As a result, the bone conduction microphone enables vibration sensor 15 to easily come into contact with the nose at an appropriate position by rotating the sensor support even when nose 205 is individually different in size and position. That is, the bone conduction microphone facilitates adjusting a position and pressure at which vibration sensor 15 come into contact with the nose.

The sensor support is bendable, and conductor wire 21 for transmitting a signal from vibration sensor 15 to head-worn part 10 may be allowed to pass through inside the sensor support.

As a result, the sensor support is bendable, so that the bone conduction microphone enables vibration sensor 15 to be adjusted in position and orientation by adjusting a degree of curvature of the sensor support. Thus, vibration sensor 15 can be easily pressed against nose 205 at an appropriate position from an appropriate direction. The bone conduction microphone enables conductor wire 21 to be hidden to be invisible from the outside by allowing conductor wire 21 to pass through the sensor support, and enables conductor wires 21 protruding from respective vibration sensors 15 to be easily combined into one conductor wire within a range of length of the sensor support.

The bone conduction microphone may be configured such that the sensor support has a lower end portion provided with clip 17 that generates urging force F in a direction of closing two arms 17a extending downward. Arms 17a of clip 17 may have respective leading ends to which corresponding left and right vibration sensors 15 are attached, vibration sensors 15 coming into contact with corresponding left and right sides of nose 205.

As a result, the bone conduction microphone includes vibration sensors 15 that are attached to respective leading ends of arms 17a, which generates urging force F, of clip 17 in a bifurcated shape, so that vibration sensors 15 each can be pressed against nose 205 with appropriate pressing force. Thus, the bone conduction microphone enables vibration of skin on the nasal bone to be appropriately picked up with good sensitivity, and also enables reducing individual difference in sensitivity of vibration sensor 15 regardless of a size of nose 205.

Bone conduction headset 5 of the above exemplary embodiment may include: vibration sensor 15 that comes into contact with nose 205 of a human body from outside the human body and converts vibration into an electric signal; head-worn part 10 that is worn on head 201 of the human body above nose 205; a sensor support that extends downward from head-worn part 10 and supports vibration sensor 15 toward nose 205; and bone conduction speaker 50 that is connected to head-worn part 10 and outputs a voice signal by vibration.

As a result, even when corrective glasses or dust-proof glasses are worn, bone conduction headset 5 can be worn above the glasses without interfering with the glasses. That is, bone conduction headset 5 can be worn regardless of whether a wearer wears glasses. Even when glasses are worn, bone conduction headset 5 can prevent vibration sensor 15 from interfering with a nose pad portion of the glasses by adjusting a position at which vibration sensor 15 comes into contact with the nose. Thus, bone conduction headset 5 can suppress decrease in detection accuracy of vibration sensor 15. Bone conduction headset 5 can adjust the position at which vibration sensor 15 comes into contact with nose 205 by providing the sensor support with an adjustment function. Thus, bone conduction headset 5 enables vibration sensor 15 to come into close contact with a position with high sensitivity in accordance with a position and a size of nose 205, and enables vibration of skin on the nasal bone to be appropriately picked up. Even in a situation where an ambient sound is loud and a wearer is less likely to hear, bone conduction headset 5 enables transmitting desired sounds clearly to the wearer by bone conduction using bone conduction speaker 50.

The present disclosure is useful for a bone conduction microphone, a bone conduction headset, and the like that allow the bone conduction microphone to be separately worn and can suppress decrease in detection accuracy of vibration of skin on the nasal bone even when a living body wears glasses.

What is claimed is:

1. A bone conduction microphone comprising:
a vibration sensor that comes into contact with a nose of a living body from outside the living body and converts vibration into an electric signal;
a head-worn part that is worn on a head of the living body; and
a sensor support that hangs from the head-worn part and supports the vibration sensor toward the nose.

2. The bone conduction microphone according to claim 1, wherein the sensor support has an upper end connected to the head-worn part, and hangs from the upper end and passes through a portion in front of a glabella of the head of the living body to support the vibration sensor.

3. The bone conduction microphone according to claim 1, wherein the head-worn part includes,
a head-worn part body to be worn on the head, and
a support base member that is supported by the head-worn part body and is connected to an upper end of the sensor support, a central portion of the support base member being located in front of a forehead of the head of the living body in a noncontact state with the head-worn part body when the head-worn part is worn, by connecting left and right end portions of the support base member to the head-worn part body, the left and right end portions being positioned near a temporal region when the head-worn part is worn.

4. The bone conduction microphone according to claim 3, wherein each of the left and right end portions of the support base member is connected to the head-worn part body in a rotatable manner in an up-and-down direction.

5. The bone conduction microphone according to claim 3, wherein the sensor support is connected to the support base member in a rotatable manner in the up-and-down direction.

6. The bone conduction microphone according to claim 1, further comprising:
a conductor wire passing through inside the sensor support, the conductor wire transmitting the electric signal from the vibration sensor to the head-worn part,
wherein the sensor support is bendable.

7. The bone conduction microphone according to claim 4, wherein the sensor support has a lower end portion provided with a clip that generates urging force in a direction of closing two arms of the clip hanging downward, and
the two arms of the clip have respective leading ends to which corresponding left and right vibration sensors including the vibration sensor are attached, the vibration sensors coming into contact with corresponding left and right sides of the nose.

8. A bone conduction headset comprising:
a vibration sensor that comes into contact with a nose of a living body from outside the living body and converts vibration into an electric signal;
a head-worn part that is worn on a head of the living body;
a sensor support that hangs from the head-worn part and supports the vibration sensor toward the nose; and
a bone conduction speaker that is connected to the head-worn part and outputs a voice signal by vibration.
